(19) United States
(12) Patent Application Publication
(10) Pub. No.: US 2026/0249618 A1
(43) Pub. Date: Aug. 27, 2026

(54) SYSTEM FOR LASER MARKING OF PRODUCTS

(71) Applicant: Husky Injection Molding Systems Ltd., Bolton (CA)

(72) Inventor: Christophe Halter, Arlon (BE)

(73) Assignee: Husky Injection Molding Systems Ltd., Bolton, ON (CA)

(21) Appl. No.: 18/861,635

(22) PCT Filed: May 1, 2023
(86) PCT No.: PCT/CA2023/050584

§ 371 Date: Oct. 30, 2024

Related U.S. Application Data
(60) Provisional application No. 63/363,968, filed on May 2, 2022.

(51) Int. Cl. B41J 2/44; B41J 2/525; B41J 3/407

(52) U.S. Cl. CPC B41J 2/442; B41J 2/525; B41J 3/40733

(57) ABSTRACT

A system for marking a product is provided. The product includes a markable region having: at least one first region of a photoactivatable material, at a first depth in a wall of the product, and at least one second region of the photoactivatable material, at a second depth in the wall of the product. The system comprises: a laser configured to emit a beam having a beam energy density above a threshold energy density; a beam modulator component configured to modulate a focusing distance of the beam to: a first focusing distance which is incident on the at least one first region for creating the markings in the at least one first region, and a second focusing distance incident on the at least one second region for creating the markings in the at least one second region.

### FIELD

The present technology broadly relates to systems and methods for printing on products; and in particular, to systems and methods for marking containers produced from molded articles.

### BACKGROUND

Molding is a process by virtue of which an article can be formed from molding material by using a molding system, such as an injection molding process. As one example of a molded article, molding systems could produce a preform that is blow moldable into a container, such as a bottle or the like. Such preforms are typically molded from a thermoplastic such as polyethylene terephthalate (PET) and are otherwise moldable from other thermoplastics such as, for example, high-density polyethylene (HDPE), or polypropylene (PP). Moreover, it is known to mold preforms having a multilayer structure for imparting desired properties to the container blow molded therefrom.

Containers typically include printing for functional and/or decorative purposes. Functional markings may provide, for example, notice to a consumer as to the content of the container (for example, product, volume, best before date, etc.), brand information (for example, vendor name, product trade-name), a source thereof (for example, fabrication or bottling location). Other functional markings may provide machine readable information such as a universal product code (UPC) to facilitate a purchase transaction and/or inventory management. Other functional markings could include markings to denote the type(s) of material used therein to facilitate post-consumer activity such as recycling. Decorative features may include, for example, images, colors, and patterns. Some markings are both decorative and functional with familiar patterns and colors being used to convey brand information.

Such markings are typically printed onto labels and/or sleeves that are then applied to the container. It is also known to print onto the container during or after the molding thereof. Markings could include engravings formed in a mold or a post-molding operation using various techniques, such as laser engraving.

However, applying colorful markings directly on the containers remains challenging. Certain prior art approaches have been proposed to tackle the above-identified technical problem.

U.S. Pat. No. 8,557,715-B2 issued on Oct. 15, 2013, assigned to National Cheng Kung University, and entitled “MARKING CO2 LASER-TRANSPARENT MATERIALS BY USING ABSORPTION-MATERIAL-ASSISTED LASER PROCESSING”, discloses a method including: providing a first substrate, which has a top surface and a bottom surface; providing a second substrate which has a top surface; putting the bottom surface of the first substrate on the top surface of the second substrate; irradiating a CO2 laser beam to the top surface of the second substrate by passing through the top surface and the bottom surface of the first substrate; and forming a mark on the bottom surface of the first substrate. The material of the mark is oxide of the second substrate or the same as the material of the second substrate. Whereby the cheap CO2 laser is utilized to form the mark on the first substrate, and the mark can be erased easily by a proper chemical for recycling the first substrate.

U.S. Pat. No. 6,852,948-B1 issued on Feb. 8, 2005, assigned to Thermark LLC, and entitled “HIGH CONTRAST SURFACE MARKING USING IRRADIATION OF ELECTROSTATICALLY APPLIED MARKING MATERIALS”, discloses a method of radiantly marking substrates including metals, plastics, ceramic materials, glazes, glass ceramics, and glasses of any desired form, which comprises electrostatically applying to the material to be marked a variable thickness layer of marking material containing energy absorbing components and/or enhancers, then irradiating said layer with a radiant energy source such as a laser or diode based energy source such that the radiation is directed onto said layer, optionally in accordance with the form of the marking to be applied, preferably using a laser or diode based energy source of a wavelength which is sufficiently absorbed by the marking material so as to create a bonding of the marking material to the surface of the workpiece at the irradiated areas.

United States Patent Application Publication No.: 2009/128,615-A1 published on May 21, 2009, assigned to DataLase Ltd, and entitled “PRINTING SYSTEM”, discloses a substrate-marking system comprising a substrate-marking apparatus and a substrate which is susceptible, or includes an additive which is susceptible, to changing color upon irradiation. The apparatus comprises a laser diode for emitting a beam of laser light and a galvanometer for aligning a desired point on the substrate with the laser beam such that the laser beam irradiates the desired point thus causing the additive, in use, to change color at the point.

U.S. Pat. No. 5,886,318-A issued on Mar. 23, 1999, assigned to Vasiliev et al., and entitled “METHOD FOR LASER-ASSISTED IMAGE FORMATION IN TRANSPARENT OBJECTS”, discloses a method for laser-assisted image formation in transparent specimens including establishing a laser beam having different angular divergence values in two mutually square planes, followed by focusing the laser beam at a present point of the specimen. In the course of image formation the specimen is displaced with respect to the point of radiation focusing in order to change an angle between the plane with a maximum laser beam angular divergence and the surface of the image portion being formed so as to suit the required contrast of the image portion involved.

U.S. Pat. No. 7,158,145-B1 issued on Jan. 2, 2007, assigned to Orga Systems GmbH, and entitled “METHOD FOR APPLYING COLORED INFORMATION ON AN OBJECT”, discloses a method for applying colored information to an object, the object having at least two different chromophoric particles, at least in a layer close to the surface, which change the color of this layer under the influence of laser radiation, laser radiation having at least two different wavelengths being used in order to change the color of this layer, the object being acted on by laser radiation in the vector and/or raster method by means of a two-coordinate beam deflection device and a focusing device for focusing the laser radiation onto the layer of the object.

U.S. Pat. No. 8,411,120-B2 issued on Apr. 2, 2013, assigned to 3M Innovative Properties Co, and entitled “GENERATION OF COLOR IMAGES”, discloses methods for generating a color image including a multi-layer construction in which at least one of the layers is a thermally activatable layer that includes a thermally activatable composition. The thermally activatable composition includes a non-linear light to heat converter composition and a color forming compound. Upon activation with a light source an image forms.

International Patent Application Publication No.: 2011/104,331-A1 published on Sep. 1, 2011, assigned to Wurm et al., and entitled “MARKING DEVICE AND METHOD FOR THE COLORED MARKING OF VALUE OR SECURITY DOCUMENTS”, discloses a method for the permanent, in particular distinct, multicolored marking of value and/or security documents. The method for the permanent colored marking of a value or security document comprises: providing a document body which comprises regions having different colors, wherein each of the individual regions is single-colored; providing a marking device which comprises at least one laser light source for generating laser light and a light guide device which is coupled to the at least one laser light source such that a focus of the laser light of the laser light source can be positioned in a controlled manner on or in the document body of the value or security document; iteratively deliberately positioning the focus on or in the document body and irradiating the laser light in order to deliberately change the color of one or more regions locally so that subsequently the document body conveys a multicolored color effect to a human observer when irradiated with white light, wherein the laser light is irradiated by means of short or ultrashort laser pulses which have a pulse duration of less than 100 ps or less than 10 ps. As a result, non-linear interactions between the material of the value or security document and the laser light can be utilized for marking. In this way, improved focusing of the laser light, and consequently a higher density of the colored markings establishing the color, can be utilized or produced, so that higher color intensity can be implemented.

United States Patent Application Publication No.: 2008/111,877-A1 published on May 15, 2008, assigned to Dymo NV, and entitled “THERMAL LASER PRINTING”, discloses a direct thermal printing material having at least one planar layer containing thermally activatable materials, wherein said planar layer forms an image upon application of laser light.

### SUMMARY

It is an object of the present technology to address at least some inconveniences associated with the prior art.

Developers of the present technology have appreciated that markings including different colors can be created within a wall of the container by applying laser irradiation to regions thereof defined at different depth values therewithin.

More specifically, the developers have appreciated that each of such regions defined through the depth of the wall of the container may be pre-configured for developing a different respective color when exposed to the laser irradiation of a respective energy density value. Thus, the developers have devised a system that, in at least some non-limiting embodiments thereof, can be configured for (i) focusing a laser beam of a laser at different focusing distances corresponding to the depth values of the different respective regions; and (ii) adjusting certain parameters of the laser beam, such as intensity or wavelength thereof, to generate the laser irradiation of a desired energy density value, to which a given region, defined at a respective depth value within the wall of the container, is configured for reacting.

By doing so, depending on a particular energy density value of the laser irradiation applied to the different regions and/or composition thereof, non-limiting embodiments of the present system may allow creating an array of colors along the depth of the wall of the container, thereby providing for direct application of colorful markings thereto.

It should be noted that the system described herein is not limited to containers having been produced from molded articles (preforms), and can be applied to other products whose materials are reactive to laser irradiation, such as fast-moving consumer goods and packaging material thereof, and the like.

More specifically, in accordance with a first broad aspect of the present technology, there is provided a system for marking a product. The product includes a markable region having: at least one first region of a photoactivatable material, at a first depth in a wall of the product, for forming markings when activated by a first incident beam above a first threshold energy density, and at least one second region of the photoactivatable material, at a second depth in the wall of the product, for forming markings when activated by a second incident beam above a second threshold energy density. The system comprises: at least one laser configured to emit a beam having a beam energy density above one of the first threshold energy density and the second threshold density energy at a focal region of the beam and a beam energy density below the one of the first threshold energy density and the second threshold density energy outside of the focal region of the beam; a beam modulator component configured to modulate a focusing distance of the beam; a processor communicatively coupled to the beam modulator component, the processor being configured to cause the beam modulator to modulate the focusing distance of the beam to: a first focusing distance which is incident on the at least one first region for creating the markings in the at least one first region, and a second focusing distance incident on the at least one second region for creating the markings in the at least one second region.

In certain embodiments, the at least one first region has been produced from a first photoactivatable material; and the at least one second region have been produced from a second photoactivatable material, different from the first photoactivatable material.

In certain embodiments, the first photoactivatable material is configured for forming markings of a first color when activated by the first incident beam; and the second photoactivatable material is configured for forming markings of a second color when activated by the second incident beam; and wherein the processor is configured to cause the beam modulator to modulate the focusing distance of the beam to: the first focusing distance which is incident on the at least one first region for creating the markings of the first color in the at least one first region, and a second focusing distance incident on the at least one second region for creating the markings of the second color in the at least one second region.

In certain embodiments, the second threshold energy density is different from the first threshold energy density; and wherein the at least one laser is configured to modulate the beam energy density of the beam between at least the first threshold energy density and at least the second threshold energy density.

In certain embodiments, the processor is further communicatively coupled to the at least one laser for causing adjustments to an emitted energy density of the at least one laser.

In certain embodiments, the at least one laser includes at least one tunable laser configured for emitting: at least a first wavelength suitable for absorption by the first photoactivatable material, and at least a second wavelength suitable for absorption by the second photoactivatable material.

In certain embodiments, the at least one laser is a Near Infrared (NIR) laser.

In certain embodiments, the at least one laser includes a first laser and a second laser, the first laser being configured to emit a first beam of at least a first wavelength suitable for absorption by the first photoactivatable material, the first beam having a beam energy density above the first threshold energy density at a first focal region of the first beam and a beam energy density below the first threshold energy density outside the first focal region, and the second laser being configured to emit a second beam of at least a second wavelength suitable for absorption by the second photoactivatable material, the second beam having a beam energy density above the second threshold energy density at a second focal region of the second beam and a beam energy density below the second threshold energy density outside the second focal region; and the processor is configured to cause the beam modulator to modulate: (i) the focusing distance of the first beam to the first focusing distance for creating the markings of the first color in the at least one first region; and (ii) the focusing distance of the second beam to the second focusing distance for creating the markings of the second color in the at least one second region.

In certain embodiments, the first laser of a first laser type, and the second laser of a second laser type, different from the first laser type.

In certain embodiments, the first laser type is configured for causing foaming of the at least one first layer, thereby creating the markings of the first color therein; and the second laser is configured for causing carbonization of the at least one second layer, thereby creating the markings of the second color therein.

In certain embodiments, the first laser type comprises a Near Infrared (NIR) laser, and the second laser type comprises a carbon dioxide laser.

In certain embodiments, the first color is different from the second color.

In certain embodiments, the markable region of the products has at least one third region, at a third depth in a wall of the product, encapsulated by the at least one first region and the at least one second region, the at least one third region being of a third photoactivatable material which can form markings having a third color when activated by an incident beam above a third threshold energy density; and the processor is further configured to cause the beam modulator to modulate the focusing distance of the beam to a third focusing distance which is incident on the at least one third region for creating the markings in the at least one third region.

In certain embodiments, the at least one laser is configured to emit the beam having the focal region smaller in depth than that of any one of the at least one first region and the at least one second region of the markable region.

In certain embodiments, the product has a layered structure and each one of the at least one first region and the at least one second region corresponds to a respective layer of the layered structure.

In certain embodiments, the product is a container having been produced from a moldable article.

In accordance with a second broad aspect of the present technology, there is provided a method for marking a product in a markable region thereof. The markable region includes: at least one first region of a photoactivatable material for forming markings therein when activated by a first incident beam above a first threshold energy density, and at least one second region of the photoactivatable material for forming the markings therein when activated by a second incident beam above a second threshold energy density. The method is executable by a processor communicatively coupled to a beam modulator. The method comprises: causing, by the processor, the beam modulator to modulate a focusing distance of a beam, incident thereon along a first optical axis, to a first focusing distance which is incident on the at least one first region for creating the markings in the at least one first region; causing, by the processor, the beam modulator to modulate the focusing distance of the beam to a second focusing distance which is incident on the at least one second region for creating the markings in the at least one second region, the beam having a beam energy density above one of the first threshold energy density and the second threshold density energy at a focal region of the beam and a beam energy density below the one of the first threshold energy density and the second threshold density energy outside of the focal region of the beam.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

The detailed description of illustrative (non-limiting) embodiments will be more fully appreciated when taken in conjunction with the accompanying drawings, in which:

FIG. 1 depicts a flow diagram of a process for producing molded products, in accordance with certain non-limiting embodiments of the present technology;

FIG. 2 depicts a schematic diagram of a molding system configured for producing molded articles, in accordance with certain non-limiting embodiments of the present technology;

FIG. 3A depicts an example molded article that is moldable in a mold of the molding system of FIG. 1, the molded article being configured as a preform of the type that is blow moldable to form a container, in accordance with certain non-limiting embodiments of the present technology;

FIG. 3B depicts an enlarged view of a wall portion of the molded article, preform, as indicated in FIG. 3A, in accordance with certain non-limiting embodiments of the present technology;

FIG. 3C depicts an example container molded from the preform depicted in FIG. 3A, in accordance with certain non-limiting embodiments of the present technology;

FIG. 3D depicts an enlarged view of a wall portion of the container as indicated in FIG. 3C, in accordance with certain non-limiting embodiments of the present technology;

FIGS. 4A and 4B depict a schematic diagram of a printing procedure for printing onto the container of FIG. 3C, in accordance with certain non-limiting embodiments of the present technology;

FIG. 5 depicts a schematic diagram of a printing system configured for executing the container printing procedure as indicated in FIGS. 4A and 4B, in accordance with certain non-limiting embodiments of the present technology;

FIG. 6 depicts a flow chart diagram of a method of marking the container of FIG. 3C using the printing system of FIG. 5, in accordance with certain non-limiting embodiments of the present technology; and

FIG. 7 depicts a schematic diagram of using the printing system of FIG. 5 for applying the markings at different regions within the wall of the container of FIG. 3C, in accordance with certain non-limiting embodiments of the present technology.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified embodiments of the present technology. As persons skilled in the art would understand, various embodiments of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and embodiments of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

With these fundamentals in place, we will now consider some non-limiting examples to illustrate various embodiments of aspects of the present technology.

### Production Process Overview

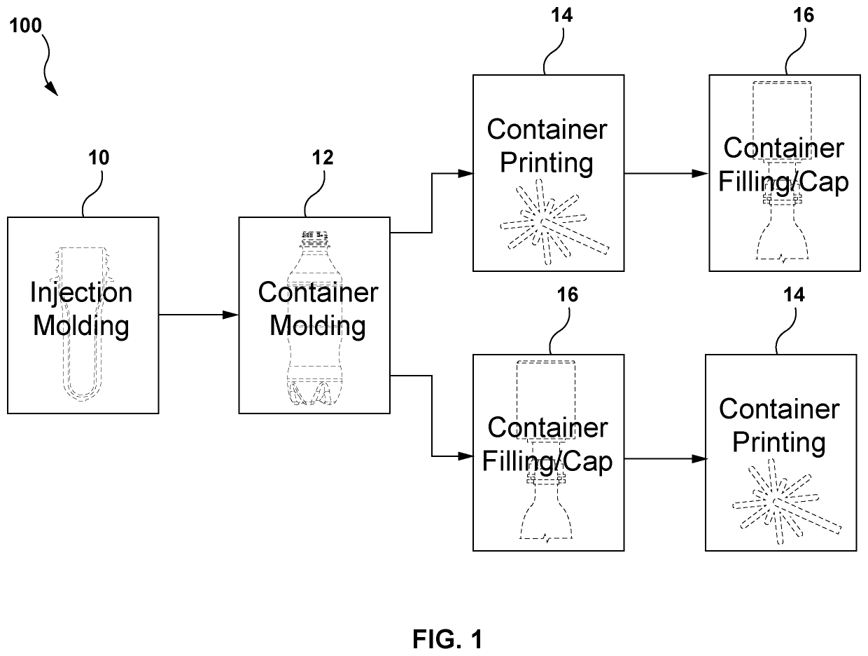

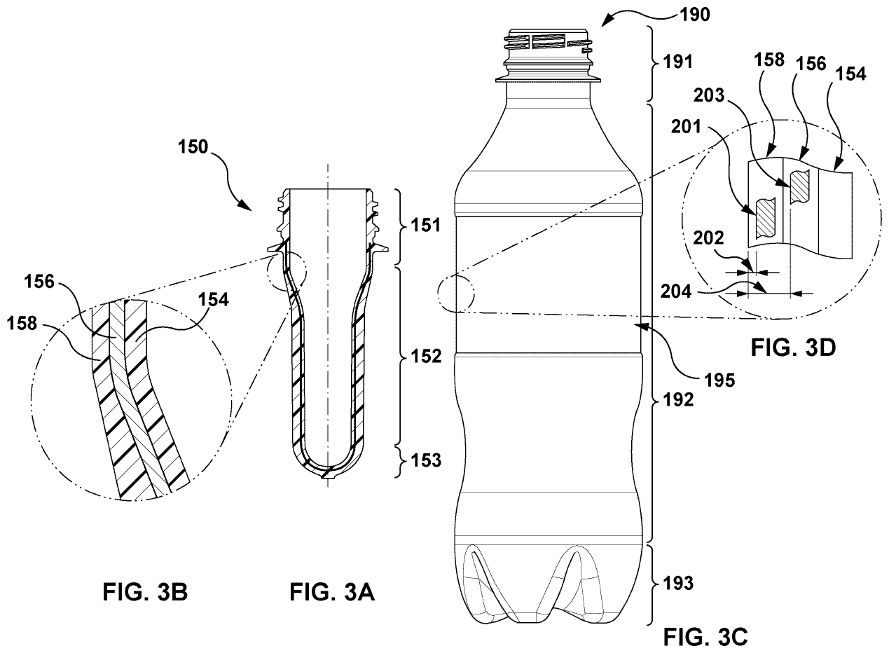

With reference to FIG. 1, there is depicted a schematic diagram of a process 100 for producing packaged products, including molding, forming, filling/capping and printing of a completed container, such as a container 190 depicted in FIG. 3C, in accordance with certain non-limiting embodiments of the present technology.

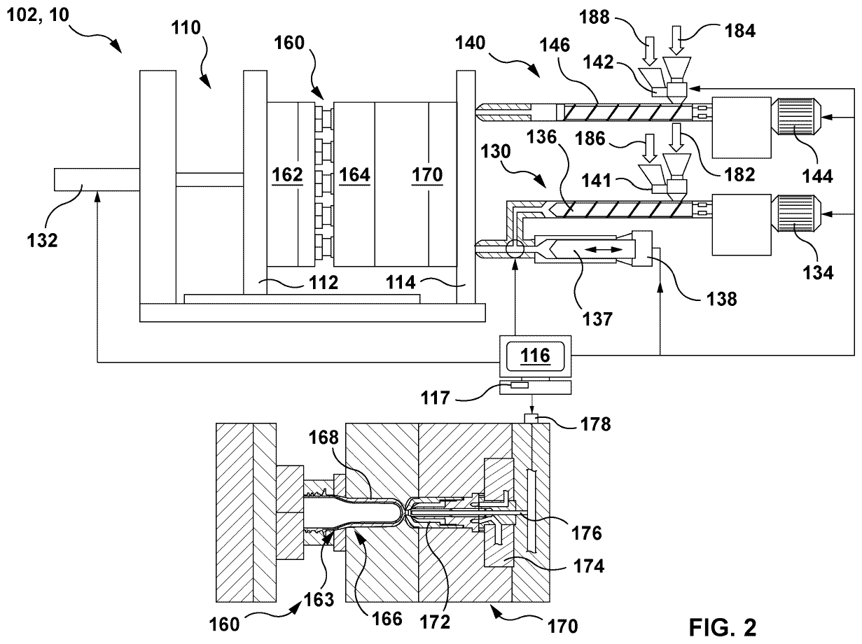

As best shown in FIG. 1, the process 100 includes certain procedures directed to producing the container 190. The process 100 includes an injection molding procedure 10 for producing a molded article, such as a molded article 150 depicted in FIG. 3A, from which the container 190 can be produced. According to certain non-limiting embodiments of the present technology, the molded article 150 can be produced by a molding system 102 described hereinbelow with reference to FIG. 2.

Further, the process 100 includes a container molding procedure 12 for forming the container 190 from the molded article 150. According to certain non-limiting embodiments of the present technology, the container molding procedure 12 can be executed by a forming system (not depicted). Broadly speaking, the forming system can be configured to: (i) obtain the molded article 150, such as from the molding system 102; (ii) clamp the molded article 150 in a container mold representative of a desired form to be given to the container 190; and (iii) inject, typically under high pressure, an inflating agent (such as air or liquid, as an example) into the molded article 150, thereby causing walls of the molded article 150 to stretch out and match the form of the container mold. This process is generally referred to as blow-molding. Additionally, the forming system could be configured to cool down the container 190 thus produced in the container mold until the material thereof is sufficiently hardened. It should be expressly understood that other configurations of the forming system are envisioned without departing from the scope of the present technology, such as those configured for extrusion molding, compression molding, injection-compression molding, blow-trim molding of the molded article 150, and the like.

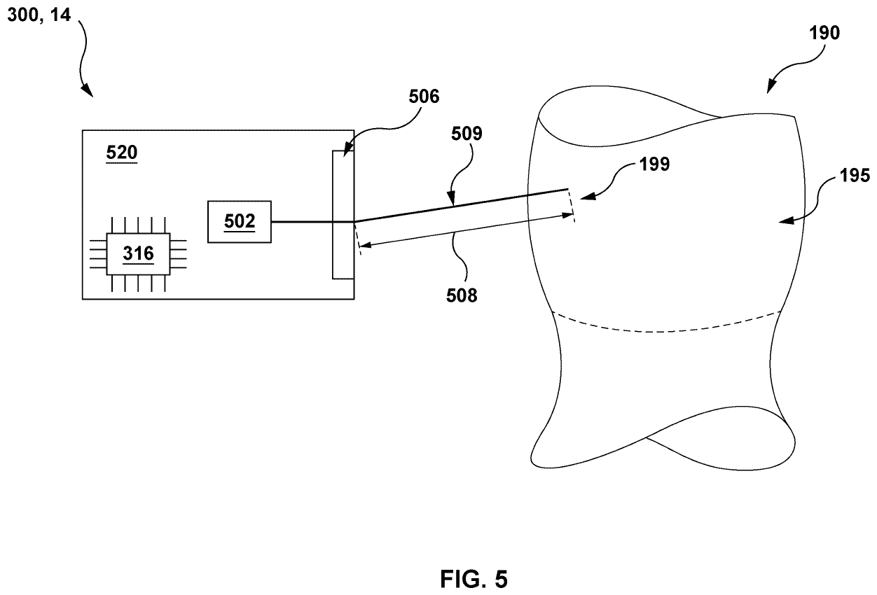

Further, the process 100 includes a container printing procedure 14 for printing markings on the container 190, which can include various decorative and functional markings. The markings could include, but are not limited to, a brand image, a logo, a product name, and a UPC code. According to certain non-limiting embodiments of the present technology, the container printing procedure 14 can be executed directly on the container 190, by selective irradiation of one or more points of the container 190. For example, the container printing procedure 14 can be executed by a printing system 300 described herein below with reference to FIG. 5.

Further, the process 100 includes a container filling and capping procedure 16 for filling the container 190 with a packaged product, such as a beverage, and capping the container 190. According to certain non-limiting embodiments of the present technology, the container filling and capping procedure 16 can be executed by a filling and capping system (not depicted). Broadly speaking, the filling and capping system can be configured to dose the product in the container 190 according to a volume thereof and further put a cap on an open end of the container 190 to securely encapsulate the packaged product in the container 190.

As it can be appreciated form FIG. 1, in some non-limiting embodiments of the present technology, the container printing procedure 14 could be executed prior to the container filling and capping procedure 16. In other non-limiting embodiments of the present technology, the container printing procedure 14 could be executed after the container filling and capping procedure 16.

### Injection Molding Procedure

With reference to FIG. 2, there is depicted a schematic representation of a molding system 102, in accordance with certain non-limiting embodiments of the present technology, configurable for executing the injection molding procedure 10. The molding system 102 is configured as an injection molding system that is capable of molding molded articles, such as the molded article 150 depicted in FIG. 3A and mentioned above. In the illustrated non-limiting embodiment, the molded article 150 is a multilayer preform of the type that is re-moldable, at least in part by blow molding or liquid molding, for example, into the container 190 as depicted in FIG. 3C.

According to certain non-limiting embodiments of the present technology, the molding system 102 includes a clamp 110, an injection unit 130, an auxiliary injection unit 140, a mold 160, and a controller 116.

In some non-limiting embodiments of the present technology, the clamp 110 includes a stationary platen 114 and a moveable platen 112 that are supported on a base (not separately labelled). In operation, the moveable platen 112 is moveable relative to the stationary platen 114 by means of a clamp actuator 132 for opening, closing and otherwise clamping the mold 160. The clamp actuator 132 is communicatively coupled to the controller 116 whereby the controller 116 is able to control the operation thereof.

In some non-limiting embodiments of the present technology, the injection unit 130 includes, amongst other things, a plasticizer 136 and a separate shooting pot 137. As such the injection unit 130 is configured as a so-called two-stage injection unit that is capable of plasticizing during injection. The plasticizer 136 is operated by a plasticizing actuator 134 for plasticizing a first thermoplastic material 182 therein. The shooting pot 137 is operated by an injection actuator 138 for injecting the first thermoplastic material 182 into a hot runner 170 of the mold 160. The plasticizing actuator 134 and the injection actuator 138 are connected to the controller 116 whereby the controller 116 can control the operation thereof.

The composition of the first thermoplastic material 182 is not particularly limited. Thus, in some non-limiting embodiments of the present technology, the first thermoplastic material 182 could include but is not limited to polyethylene terephthalate, high-density polyethylene, and polypropylene.

Likewise, in some non-limiting embodiments of the present technology, the auxiliary injection unit 140 includes, amongst other things, an auxiliary plasticizer 146 and an auxiliary plasticizing actuator 144. The auxiliary injection unit 140 is configured as a reciprocating screw type injection unit. The auxiliary plasticizer 146 is operated by the auxiliary plasticizing actuator 144 for plasticizing and injecting a second thermoplastic material 184 into the hot runner 170 of the mold 160.

In some non-limiting embodiments of the present technology, the composition of the second thermoplastic material 184 can be similar to that of the first thermoplastic material 182, such as one of polyethylene terephthalate, high-density polyethylene, and polypropylene. However, in other non-limiting embodiments of the present technology, the second thermoplastic material 184 can be different from the first thermoplastic material 182. Such composites could be included to impart certain desirable properties, for example, improved barrier resistance to the migration of gas and moisture through a wall of the container. To that end, the second thermoplastic material 184 could include nylon, PolyGlycolide Acid (PGA), and Ethylene Vinyl Alcohol (EVOH), amongst many others. In yet other non-limiting embodiments of the present technology, the second thermoplastic material 184 could include composites unstable in contact with water (that is, soluble and/or degradable) such as a water-soluble polymer or a hydro-degradable polymer. For example, water-soluble polymers may include ethylene vinyl alcohol, poly vinyl alcohol, polyethylene glycol, dextrans, pullulan, poly vinyl pyrrolidone, poly acrylic acid, poly acrylamide, poly oxazoline, poly phosphates or cellulose. Further, hydro-degradable polymers may include one of PGA, sugar/polysaccharide starch, polyglycolide, polycaprolactone, poly lactic acid, and polyhydroxyalkanoates. A technical effect of the foregoing may include improved recyclability of the container 190 produced using the second thermoplastic material 184.

Further, in some non-limiting embodiments of the present technology, the first thermoplastic material 182 and/or the second thermoplastic material 184 could be intrinsically photo-sensitive such that its visual appearance changes upon exposure to light irradiation. The change of visual appearance or the degree of changes imparted could depend on various properties of the thermoplastic materials 182, 184 and/or the light source, such as an energy density level and/or wavelength of the incident light.

According to non-limiting embodiments of the present technology, photo-sensitive properties could be provided to either one or both of the first thermoplastic material 182 and the second thermoplastic material 184 by adding thereto a photo-sensitive additive. In the illustrated embodiment, a first photo-sensitive additive 186 is added to the first thermoplastic material 182. To that end, as further depicted in FIG. 1, the injection unit 130 further includes a first blender device 141 at an inlet thereof, also referred to as a dosing device. The first blender device 141 is configured to blend or otherwise dose a flow of the first thermoplastic material 182 and the first photo-sensitive additive 186. The plasticizing actuator 134 and the first blender device 141 can thus be connected to the controller 116 whereby the controller 116 is able to control the operation thereof.

Further, in some non-limiting embodiments of the present technology, a second photo-sensitive additive 188 is added to the second thermoplastic material 184. To that end, the auxiliary injection unit 140 further includes a second blender device 142 at an inlet thereof. The second blender device 142 is configured to blend or otherwise dose a flow of the second thermoplastic material 184 and the second photo-sensitive additive 188. The auxiliary plasticizing actuator 144 and the second blender device 142 can thus be connected to the controller 116 whereby the controller 116 is able to control the operation thereof.

Broadly speaking, a given one of the first photo-sensitive additive 186 and the second photo-sensitive additive 188 is an additive configured for increasing sensitivity of a respective one of the first thermoplastic material 182 and the second thermoplastics material 184 to incident light having the energy density value greater than a first and second threshold energy density value, respectively. More specifically, the first photo-sensitive additive 186, for example, increases the sensitivity of the first thermoplastic material 182 such that, under laser irradiation of the energy density value greater than the first threshold energy density value, the first thermoplastic material 182 changes its reflective and/or transmissive properties, changing the visual appearance of the irradiated portions of the first thermoplastics material 182. Depending on the specific embodiment, irradiation of portions of the first thermoplastics material 182 causes either carbonization traces or foaming therein, depending on the first photo-sensitive additive 186 (described in greater detail below). At the same time, at least one of a source of the laser irradiation (such as a laser 502 described below with reference to FIG. 5) and the second thermoplastic material 184 can be selected such that the second thermoplastic material 184 is unreactive to the laser irradiation of the energy density value greater than the first threshold energy density value associated with the first photo-sensitive additive 186, and vice versa.

Further, in some non-limiting embodiments of the present technology, each one of the first photo-sensitive additive 186 and the second photo-sensitive additive 188 can be different photo-sensitive additives, meaning they can develop different colors (such as black, dark gray, light gray, or white) or discoloration effects (carbonization or foaming, for example) under the laser irradiation having energy density value above the respective one of the first and second threshold energy density values. However, in other non-limiting embodiments of the present technology, each one of the first photo-sensitive additive 186 and the second photo-sensitive additive 188 can be configured for developing sufficiently same colors.

Further, in some non-limiting embodiments of the present technology, each one of the first photo-sensitive additive 186 and the second photo-sensitive additive 188 can be activated by the laser irradiation having different properties, such as the energy density value thereof. In other words, in these embodiments, the first threshold energy density value associated with the first photo-sensitive additive 186 can be different from the second threshold energy density value associated with the second photo-sensitive additive 188. However, in other non-limiting embodiments of the present technology, each one of the first photo-sensitive additive 186 and the second photo-sensitive additive 188 can be activated by the laser irradiation having a same minimum energy density value.

Embodiments of the molding system 102 configured for adding only a single one of the first photo-sensitive additive 186 and the second photo-sensitive additive 188 to the respective one of the first thermoplastic material 182 and the second thermoplastic material 184 are also envisioned without departing from the scope of the present technology.

In a specific non-limiting example, each one of the first photo-sensitive additive 186 and the second photo-sensitive additive 188 can be one of types available from DATALASE LTD. of Unit 3, Wheldon Road, Widnes, Cheshire, WA8 8FW, United Kingdom. It should be noted that any other suitable photo-sensitive additives can be used.

Further, in some non-limiting embodiments of the present technology, the mold 160 includes, amongst other things, a moveable part 163 and a stationary part 164 that may be arranged in a closed configuration, as shown, to define a molding cavity 168 therebetween and otherwise arranged in an open configuration, not shown, for removing/ejecting the molded article 150 therefrom. Accordingly, the moveable part 163 is coupled to the moveable platen 112 of the clamp 110 whereas the stationary part 164 is coupled to the stationary platen 114 via a hot runner 170 that is disposed therebetween. The molding cavity 168 is defined by a mold stack 166 that includes a set of complimentary inserts that are arranged in the moveable and stationary parts of the mold 160. For purposes of a conceptual depiction of the mold 160 only one mold stack 166 is shown whereas in practice the mold 160 is likely to include a plurality thereof.

Further, in some non-limiting embodiments of the present technology, the hot runner 170 is configured to fluidly connect the injection unit 130 and the auxiliary injection unit 140 with the molding cavity 168. As will be appreciated by a person skilled in the art, the hot runner 170 is typical in that it includes a nozzle 172, a manifold 174 and a nozzle valve assembly 176. The manifold 174 is arranged to connect the outlets of each one of the injection unit 130 and the auxiliary injection unit 140 with inlets of the nozzle 172. The nozzle 172 is configured to split an inlet flow of the first thermoplastic material 182 with the first photo-sensitive additive 186 received from the injection unit 130, via the manifold 174, in a melted state and to direct the resulting flows towards inner and outer skin outlets (not numbered). The nozzle 172 is similarly configured to receive an inlet flow of the second thermoplastic material 184 with the second photo-sensitive additive 188 entrained therein, received from the auxiliary injection unit 140, via the manifold 174, in a melted state and to direct the resulting flow towards an intermediate outlet (not numbered) that is arranged between the skin outlet channels. The nozzle valve assembly 176 includes a valve actuator 178 that is connected to the controller whereby the controller is able to control the operation thereof. Through coordinated control, by the controller 116, of the injection unit 130, the auxiliary injection unit 140 and the nozzle valve assembly 176, amongst other controllable devices, injecting of the first thermoplastic material 182 and the second thermoplastic material 184 through selected outlets of the nozzle 172 and into the molding cavity 168 may be performed sequentially and/or simultaneously.

Within various non-limiting embodiments of the present technology, the controller 116 can be implemented as a computing apparatus having a processor (not separately numbered). The processor may be provided through the use of dedicated hardware as well as hardware capable of executing software in association with appropriate software. The processor can execute one or more functions to control operations of one or more of the components of the molding system 102. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included. The controller 116 has access to a memory (not depicted) that stores computer executable instructions 117, which computer executable instructions 117, when executed, cause the processor of the controller 116 to control operation of one or more of the components of the molding system 102 as described above.

The injection molding procedure 10 hence terminates.

### Container Molding Procedure

According to certain non-limiting embodiments of the present technology, the process 100 continues with the container molding procedure 12 where the forming system (not depicted), as described above with reference to FIG. 1, can be configured to execute the container molding procedure 12 for producing the container 190 from the molded article 150.

With reference to FIG. 3A to 3D, there are depicted schematic diagrams of the molded article 150 (the preform 150) and the container 190 formed therefrom as introduced above, in accordance with certain non-limiting embodiments of the present technology.

As best shown in FIG. 3A, the preform 150 includes a body configurable to define a storage vessel of the container 190. The preform body is generally tubular with a neck portion 151 at an open end, a base portion 153 at a closed end and a body portion 152 defined therebetween. The body portion 152 and the base portion 153 are re-moldable to provide a container body portion 192 and a container base portion 193 of the container 190, respectively. The neck portion 151 of the molded article 150 is configured to define a container neck portion 191 of the container 190. The container neck portion 191 is configured to be capped, such as by the filling and capping system described above, using a closure to enclose a volume defined within the container 190. In other embodiments, not shown, the molded article 150 may define a finished container ready to be filled and capped (that is, it does not require any post molding transformation through blow molding, liquid molding, or the like).

As is briefly described above, the molded article 150 can be formed with a layered structure by the molding system 102. More specifically, in some non-limiting embodiments of the present technology, each one of the neck portion 151, the body portion 152, and the base portion 153 of the molded article 150 may have multiple layers including, for example, an inner skin layer 154, at least one middle layer 156, and an outer skin layer 158. In the illustrated example, the inner skin layer 154 and the outer skin layer 158 are formed from the first thermoplastic material 182, and the at least one middle layer 156 is formed from the second thermoplastic material 184. A different arrangement of the materials 182, 184 is contemplated in different embodiments.

Also, it should be noted that while producing the container 190 from the molded article 150, the forming system can be configured to preserve the layered structure of the preform 150 in the container 190. As is illustrated, a wall of the container 190 has the inner skin layer 154, the at least one middle layer 156, and the outer skin layer 158 corresponding to those of the preform 150.

However, in other non-limiting embodiments of the present technology, the molded article 150, and hence the container 190 produced therefrom, may not define different layers therewithin and can include a single layer (and thus are referred to herein as “monolayer” articles) formed from one of the first thermoplastic material 182 and the second thermoplastic material 184, as described above.

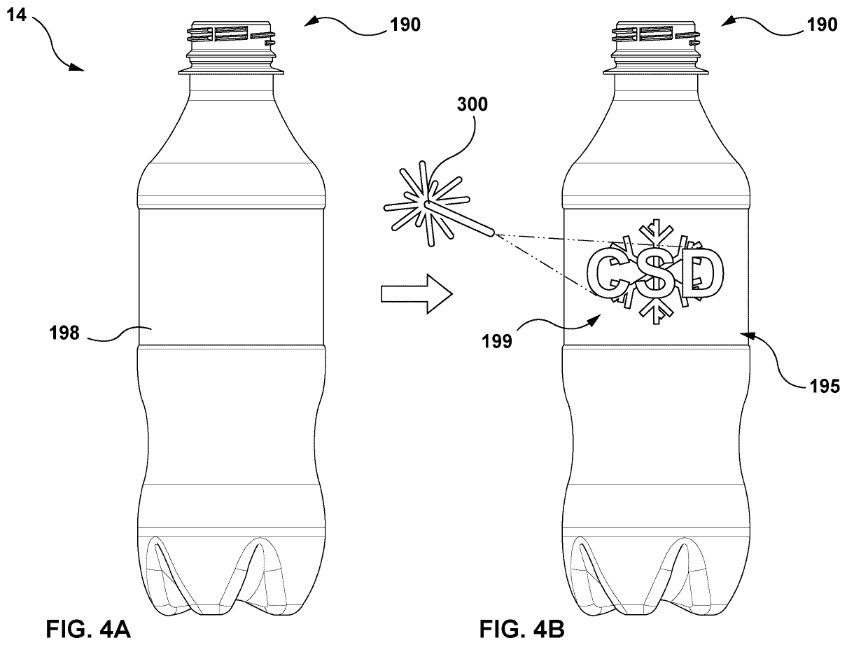

Further, the container 190 can define a markable region 195 for creating markings therein. In the embodiments illustrated in FIG. 3C (see also FIG. 4B), the markable region 195 is defined within the container body portion 192. However, in various non-limiting embodiments of the present technology, other configurations of the markable region 195 are envisioned, such as those defined in other portions of the container 190, that is, the container base portion 193 or the container neck portion 191, or corresponding to an entirety of an area thereof.

Further, according to the non-limiting embodiments of the present technology, the markable region 195 can include a plurality of regions defined through a depth of the wall of the container 190 at respective depth values from a surface thereof-such as a first region 201 and a second region 203 defined within the markable region 195 at a first depth value 202 and a second depth value 204, respectively. More specifically, a given one of the first region 201 and the second region 203 can be defined such that it has three dimensions within the wall of the container 190 and a surface area thereof, along the wall of the container 190, corresponds to a respective portion of a surface area of the markable region 195, however, located at the respective different depth value therefrom. However, it should be noted that in certain non-limiting embodiments of the present technology the surface area of the given region can correspond to that of the markable region 195.

Further, although in the illustrated embodiments, the first depth value 202 and the second depth value 204 of the first region 201 and the second region 203, respectively, have been chosen to be smaller than respective thickness values of the layers of the wall of the container 190 they are defined in, it should be expressly understood that in other non-limiting embodiments of the present technology, a respective depth value of the given region of the markable region 195 can be selected to correspond to a respective layer of the wall of the container 190—that is, the first depth value 202 of the first region 201, for example, can be selected to correspond to a thickness value of the outer skin layer 158.

Further, in yet other non-limiting embodiments of the present technology, the first region 201 may have the first depth value 202 that is greater than the thickness value of the outer skin layer 158. In other words, in these embodiments, the first region 201 of the markable region 195 can extend through at least two layers of the wall of the container 190, that is, the outer skin layer 158, and the at least one middle layer 156, as an example. In yet other non-limiting embodiments of the present technology, the first depth value 202 and the second depth value 204 can be selected such that both the first region 201 and the second region 203 of the markable region 195 can be accommodated by a single layer of the wall of the container 190, such as one of the outer skin layer 158 and the at least one middle layer 156, along the depth thereof. In other words, in these embodiments, a given one of the inner skin layer 154, the at least one middle layer 156, and the outer skin layer 158 can include, along the respective thickness thereof, more than one region of the plurality of regions of the markable region 195.

Additionally, it should be noted that, although in the embodiments illustrated in FIGS. 3C and 3D, each one of the first region 201 and the second region 202 of the markable region 195 are defined in a respective one of the outer skin layer 158 and the at least one middle layer 156 of the wall of the container 190, in those embodiments where the container 190 is a monolayer container, that is, defines only a single layer of one of the materials 182, 184, each one of first region 201 and the second region 203 can be defined in the wall thereof similarly, at the respective one of the first depth value 202 and the second depth value 204.

Further, as it can be appreciated from the description provided above with respect to the first thermoplastic material 182 and the second thermoplastic material 184, according to certain non-limiting embodiments of the present technology, the given region of the markable region 185 can be activated by the laser irradiation of selected properties (that is, wavelength, energy density value, etc.). More specifically, the given region, defined at the respective depth value within the markable region 195, can be configured for changing its visual properties (for example, opacity, color, etc.) on exposure to the laser irradiation having an energy density value above a respective threshold density value. For example, the first region 201 of the markable region 195, defined at the first depth value 202, can be configured for developing a first color on exposure to the laser irradiation above a first threshold energy density value. Further, the second region 203 of the markable region 195, defined at the second depth value 204, can be configured for developing a second color, different from the first color, on exposure to the laser irradiation above a second threshold energy density value.

According to certain non-limiting embodiments of the present technology, each one of the first region 201 and the second region 203 can be photo-sensitive to the laser irradiation above a same respective threshold energy density value, that is, the first threshold energy density value can be equal to the second threshold energy density value. However, in other non-limiting embodiments of the present technology, the first threshold energy density value can be different from the second threshold energy density value.

Further, in some non-limiting embodiments of the present technology, each one of the first region 201 and the second region 203 can be intrinsically photo-sensitive to the laser irradiation above the first threshold energy density value and the second threshold energy density value, respectively. However, in the present example, the photo-sensitive properties are added or enhanced to each one of the plurality of regions defined through the depth of the markable region 195 using a respective photo-sensitive additive, such as one of the first photo-sensitive additive 186 and the second photo-sensitive additive 188 mentioned above.

Thus, according to certain non-limiting embodiments of the present technology, the wall of the container 190 can define the markable region 195 having the plurality of regions located at the different respective depth values from the surface thereof, such as the first region 201 and the second region 203. Further, in some non-limiting embodiments of the present technology, each region of the plurality of regions can be activated, that is, configured for changing its visual appearance, such as a respective color thereof, upon exposure to the irradiation, such as from a laser, having an energy density level greater than the respective threshold energy density value.

Thus, according to the non-limiting embodiments of the present technology, the markable region 195 thus defined is configured for providing different color effects to the markings created therein. For example, in those non-limiting embodiments of the present technology where regions defined at different depth values are configured for developing a sufficiently same color but different opacity values, the markable region 195 can be configured for providing 3D effects to the markings created therein. However, in another example, where the regions defined at the different depth values therewithin are configured for developing different respective colors, the markable region 195 can be configured for providing, along the surface thereof, a matrix of different colors, which can be used for applying colorful markings to the container 190.

Thus, after the container molding procedure 12 resulted in producing the container 190 having the markable region 195 defining the plurality of regions therewithin, the process 100 advances to the container printing procedure 14 where the printing system 300 is configured to print the markings in the markable region 195 defined within the wall of the container 190 as described above.

### Printing Procedure

With reference to FIGS. 4A and 4B there is depicted a schematic diagram of the container printing procedure 14 executed by the printing system 300 for producing the markings on the container 190, such as container markings 199 within the markable region 195 in accordance with certain non-limiting embodiments of the present technology. As it can be appreciated, the container 190 in FIG. 4A is depicted prior to executing the container printing procedure 14; whereas the container 190 as depicted in FIG. 4B is post-printing, including the container markings 199.

With additional reference to FIG. 5, there is schematically depicted a functional diagram of the printing system 300 configured for creating the container markings 199 within the markable region 195 defined in the wall of the container 190, in accordance with certain non-limiting embodiments of the present technology.

Broadly speaking, the printing system 300 includes a variety of internal components including, without limitation: (1) a laser 502 configured to emit a beam 504; (2) a beam modulation component 506; and (3) a printing system controller 316.

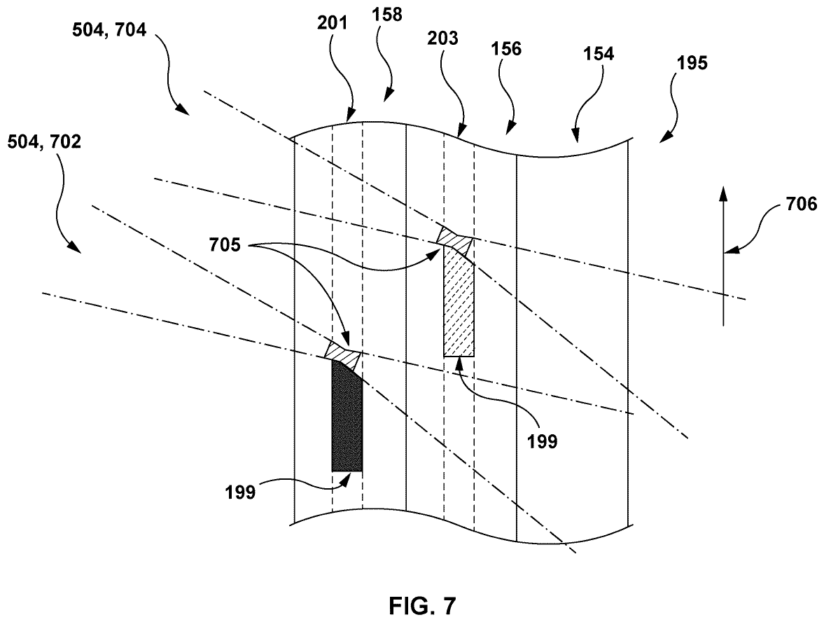

Broadly speaking, the printing system 300 can operate as follows: the beam modulation component 506 is configured to focus the beam 504, emitted by the laser 502, towards the markable region 195 at the different distances corresponding to the respective depth values of the given region therewithin, such as one of the first region 201 and the second region 203 mentioned above. Accordingly, the laser 502 and the beam modulation component 506 can be configured such that the beam 504 has, in a respective focal region thereof (such as the respective focal region 705 depicted in FIG. 7), a beam energy density value that is greater than the respective threshold energy density value associated with the given region, thereby causing the given region to change its visual appearance, such as the color thereof. Thus, by modulating at least one of (i) the beam energy density value of the beam 504 in the respective focal region 705 thereof; and (ii) a location of the respective focal region 705 of the beam 504 within the markable region 195, as will be described below, the printing system 300 can be configured to apply the container markings 199 within the markable region 195 of the container 190.

As mentioned above, according to certain non-limiting embodiments of the present technology, the container markings 199 can include functional markings and decorative markings, such as, without limitations, a brand image or a logo, a product name, product information, a bar and/or Quick Response (QR) code, and the like. As will become apparent from the description provided below, the container markings 199 thus created can have different 3D effects, such as, bevel, shading, or can include different colors, as an example.

According to certain non-limiting embodiments of the present technology, the beam modulation component 506 is configured for steering and focusing the beam 504 for forming the respective focal region 705 thereof within one or more regions the plurality of regions of the markable region 195. The beam modulation component 506 is communicatively coupled to the printing system controller 316, whereby the printing system controller 316 can be configured to control the operation of the beam modulation component 506.

In certain non-limiting embodiments of the present technology, the internal components of the printing system 300 are disposed in a common housing 520 as depicted in FIG. 5. In some embodiments of the present technology, the printing system controller 316 could be located outside of the common housing 520 and communicatively connected to the components thereof. As it can be appreciated, the printing system controller 316 can be implemented similarly to the controller 116 of the molding system 102 described above.

According to certain non-limiting embodiments of the present technology, the laser 502 is communicatively coupled to the printing system controller 316. In certain non-limiting embodiments of the present technology, the laser 502 is pre-configured for operation at a respective operating wavelength. The respective operating wavelength of the laser 502 may be in the infrared, visible, and/or ultraviolet portions of the electromagnetic spectrum. For example, the laser 502 may include at least one laser with an operating wavelength between about 650 nm and 1150 nm. Alternatively, the laser 502 may include a laser diode configured to emit light at a wavelength between about 800 nm and about 1000 nm, between about 850 nm and about 950 nm, or between about 1300 nm and about 1600 nm. In yet another example, the laser 502 can be configured to emit the laser irradiation at the respective operating wavelength between about 2000 nm and about 3500 nm, or between about 4000 nm and between about 8000 nm. In yet another example, the respective operating wavelength of the laser 502 can be between about 8000 nm and 10600 nm.

According to certain non-limiting embodiments of the present technology, the laser 502 includes a pulsed laser configured to produce, emit, or radiate pulses of light with a certain pulse duration. For example, in some non-limiting embodiments of the present technology, the laser 502 may be configured to emit pulses with a pulse duration (for example, pulse width) ranging from 10 ps to 100 ns. In other non-limiting embodiments of the present technology, the laser 502 may be configured to emit pulses at a pulse repetition frequency of approximately 100 kHz to 5 MHz or a pulse period (for example, a time between consecutive pulses) of approximately 200 ns to 10 μs. Overall, however, the laser 502 can generate the beam 504 having pulses of any suitable energy, any suitable average optical power, or peak optical power for a given application.

In other non-limiting embodiments, the laser 502 could be implemented as a continuous-wave laser without departing from the scope of the present technology. In other words, in these embodiments the laser 502 could be configured to emit the beam 504 being a continuous uninterrupted beam of light of the respective operating wavelength and any suitable average power. In some non-limiting embodiments of the present technology, the beam 504 may have a substantially circular cross-section.

It is also contemplated that the beam 504 could be unpolarized or randomly polarized, could have no specific or fixed polarization (for example, the polarization may vary with time), or could have a particular polarization, for example, the beam 504 can be linearly polarized, elliptically polarized, or circularly polarized.

Thus, in some non-limiting embodiments of the present technology, the laser 502 is configured to emit the beam 504, which, when focused on one or more points of the markable region 195, such as within the given region thereof, as described above, has the beam energy density value that is greater than the respective threshold energy density value associated with the given region and is thus sufficient for creating the container markings 199 therein.

As mentioned above, according to certain non-limiting embodiments of the present technology, different regions of the markable region 195 can be reactive to the laser irradiation having the energy density value above the respective different threshold energy density values. To that end, in some non-limiting embodiments of the present technology, the printing system controller 316 can be configured to cause the laser 502 to adjust the beam energy density value of the beam 504 in the respective focal region 705 thereof to correspond to the respective threshold energy density values associated with the different regions defined within the markable region 195, such as the first region 201 and the second region 203 mentioned above (see also FIG. 7). For example, the printing system controller 316 can be configured to modulate an input power of the laser 502.

However, in other non-limiting embodiments of the present technology, the laser 502 can be a tunable laser configured to emit the laser irradiation at different operating wavelengths corresponding to the respective threshold energy density values associated with the different regions. For example, the laser 502 can be configured to emit the beam 504 having: (1) a first wavelength suitable for being absorbed by the first region 201; and (2) a second wavelength suitable for being absorbed by the second region 203. For example, the laser 502 can be configured to emit the laser irradiation within an operating wavelength range including the first wavelength and the second wavelength. Further, to adjust the beam energy value of the beam 504 to be above those associated with one of the first region 201 and the second region 203, the printing system controller 316 can be configured to cause the laser 502 to switch a wavelength of the beam 504 to a respective one of the first wavelength and the second wavelength.

Further, in some non-limiting embodiments of the present technology, the laser 502 can be one of several laser types configured to emit the laser irradiation of different operating wavelengths or wavelength ranges. For example, the laser 502 can be of a first laser type having a first operating wavelength (wavelength range). According to certain non-limiting embodiments of the present technology, the first operating wavelength (wavelength range) can be predetermined such that the laser irradiation thereof having the energy density value equal to or greater than the respective threshold energy density value to be applied to the given region of the markable region 195 causes carbonization thereto, which can be used for creating the container markings 199 therein.

In the context of the present specification, the term “carbonization” of a material, such as that of one or more of the layers of the markable region 195, denotes partial oxidation of hydrocarbon thereof due to rupturing chemical bonds between molecules of the material by laser irradiation having a certain minimum energy density value. As a result, the oxidized hydrocarbon forms discoloration in the printing layer ranging from gray to black.

Further, in other non-limiting embodiments of the present technology, the laser 502 could be of a second laser type having a second operating wavelength (wavelength range), different from the first operating wavelength (wavelength range). According to certain non-limiting embodiments of the present technology, the second operating wavelength (wavelength range) can be predetermined such that laser irradiation thereof having the energy density value equal to or greater than the respective threshold energy density value associated with the given region defined within the markable region 195 when applied thereto causes foaming therein, which can be used for creating the container markings 199 therein.

In the context of the present specification, the term “foaming” of the material, such as that in the given region of the markable region 195, refers to melting thereof by the laser irradiation resulting in oxidizing carbon of the material forming carbon dioxide which further emerges as bubbles on the surface of the material. Foaming results in a coloration of the thermoplastic material (such as the materials 182, 184) appearing light gray to white at points receiving irradiation above the threshold.

Further, according to certain non-limiting embodiments of the present technology, the first operating wavelength (wavelength range) of the first laser type could be longer (positioned towards longer wavelengths of the electromagnetic spectrum) than the second operating wavelength (wavelength range) of the second laser type. In a specific non-limiting example, the first laser type could include a Near-Infrared (NIR) laser configured for operating within a wavelength range from around 750 nm to around 1400 nm. The second laser type could include a carbon dioxide laser with an operating wavelength of around 10600 nm. In another example, the first laser type could be a fiber laser configured for operating within a wavelength range from around 1064 nm to around 2100 nm. In yet another example, the laser 502 can include a single laser configured for operating within a wavelength range from around 750 nm to around 10600 nm. However, it should be expressly understood that other suitable lasers can be used for causing the above-described discoloration effects in the printing layer of the container 190.

In yet other non-limiting embodiments of the present technology, to modulate the beam energy density value of the output laser irradiation to be applied to a specific region of the plurality of regions defined within the markable region 195, the printing system 300 can further include another laser (not depicted), having properties different from the those of the laser 502. For example, the laser 502 can be configured to emit the beam 504 having the beam energy value, in the respective focal region 705 thereof, above the first threshold energy density value associated with the first region 201. Further, the other laser of the printing system 300 can be configured to emit another beam having another beam energy value, in a respective focal region thereof, above the second threshold energy density value associated with the second region 203. In some non-limiting embodiments of the present technology, the laser 502 and the other laser can be of a same laser type, such one of the first laser type and a second laser type, as described above. However, in other non-limiting embodiments of the present technology, each one of the laser 502 and the other laser can be of different respective laser types.

Thus, the printing system 300 can be configured to emit beams, such as the beam 504, that would have, when focused, beam energy density values above the respective threshold energy density values associated with each region of the plurality of regions defined within the markable region 195.

As is mentioned above, the beam modulation component 506 steers one of the beams produced by the printing system 300, such as the beam 504 emitted by the laser 502, to form the respective focal region 705 thereof within the given region of the markable region 195. In some non-limiting embodiments of the present technology, the beam modulation component 506 could include at least one lens (not depicted). Broadly speaking, the at least one lens is configured for converging an input light flow of the beam 504 in the respective focal region 705 thereof at a focusing distance 508.

In some non-limiting embodiments of the present technology, the at least one lens can be configured for providing a respective one of the first focusing distance 509 and the second focusing distance 511 being one of 1.5 inch, 2.0 inch, 3.0 inch, and 4.0 inch, as an example.

However, in other non-limiting embodiments of the present technology, the at least one lens could include a lens system configured for focusing the beam 504 at a plurality of focusing distances from the lasers 502 for example at 1.5 inch, 2.0 inch, 3.0 inch, and 4.0 inch. In another example, the lens system could be configured for smooth adjustment of the focusing distance within a predetermined range of distances, from 1.5 inch to 4.0 inch for example. To that end, the lens system could be communicatively coupled to one or more actuators (further coupled to the printing system controller 316) configured to move or adjust the lens system for providing a desired focusing distance from the lens system.

In certain non-limiting embodiments of the present technology, the beam modulation component 506 may further include a variety of other optical components and/or mechanical-type components for performing the steering and focusing beams produced by the printing system 300. For example, the beam modulation component 506 may include one or more mirrors, prisms, lenses, MEM components, piezoelectric components, optical fibers, splitters, diffractive elements, collimating elements, and the like. It should be noted that the beam modulation component 506 may also include one or more additional actuators (not separately depicted) driving at least some of the other optical components to rotate, tilt, pivot, or move in an angular manner about one or more axes, for example.

It is not limited how the focusing distance 508 is selected for focusing the beam 504 thereat; and in some non-limiting embodiments of the present technology, can depend on a depth of the respective focal region 705 of the beam 504. For example, as will become apparent from the description provided below, the focusing distance 508 can be predetermined such that the depth of the respective focal region 705 of the beam 504 is no greater than a depth of the given region of the markable region 195 to which the beam 504 is to be applied.

Thus, in some non-limiting embodiments of the present technology, the printing system controller 316 can be configured to cause the beam modulation component 506 to adjust the focusing distance 508 of the beam 504 to a respective distance corresponding to the given region of the markable region 195 for creating the container markings 199 in the given region, as will be described in greater detail below. By doing so, the printing system controller 316 is configured to cause sufficient energy density value to the given region of the markable region 195 to create the container markings 199 therein.

Additional components of the printing system 300 are envisioned without departing from the scope of the present technology. For example, in some non-limiting embodiments of the present technology, the printing system 300 can include a camera (such as a Charge-Coupled Device (CCD) camera or an array thereof, not depicted) communicatively coupled to the printing system controller 316 for recognizing the container 190 before applying the container markings 199 thereon. For example, using the camera (not depicted) of the printing system 300, the printing system controller 316 can be configured to define a coordinate system (such as a Cartesian coordinate system, as an example) associated with the container 190 and further determine thereon a location of the markable region 195 within the wall of the container 190 and further that of the given region defined therein.

Further, the printing system controller 316 can be configured to receive, as part of program instructions thereof, an indication of point coordinates of points, in the coordinate system associated with the container 190, defining the container markings 199. By doing so, the printing system controller 316 can be configured to identify the given region in the markable region 195 for further forming the respective focal region 705 of the beam 504 thereat.

Further, to apply the container markings 199 within the given region or to other regions of the markable region 195, the printing system controller 316 can be configured to cause the beam modulation component 506 to modulate the focusing distance 508 of the beam 504 to other respective distances corresponding to other locations along the surface of the give regions or to the other regions, thereby causing formation of the respective focal region 705 therein.

However, in other non-limiting embodiments of the present technology, to cause the respective focal region 705 of the beam 504 to displace along the surface of the given region or to the other regions defined within the markable region 195, at least some components of the printing system 300, such as the laser 502 and the beam modulation component 506 arranged as described above, can be caused to move, such as by a robotic arm (not depicted). Broadly speaking, the robotic arm can include a number of segments (or otherwise linking elements) interconnected by joints, each including a respective individual actuator coupled thereto, such as one of an electric, hydraulic, or pneumatic motor. A given joint can thus allow for at least one of a revolving, yawing, and pitching movement of a respective segment attached thereto mimicking functionality of the human arm. The actuators can further be communicatively coupled to the printing system controller 316 of the printing system 300, whereby the printing system controller 316 can be configured to actuate the actuators of the joints of the robotic arm, thereby providing up to six degrees of freedom to a terminal segment thereof, or “an end effector”, to which the at least some components of the printing system 300 configured for steering the beam 504 can be attached.

In other non-limiting embodiments of the present technology, the robotic arm can comprise a Cartesian coordinate robot, where the joints allow translational movements of the segments attached thereto. Embodiments where the container 190 is additionally caused to move relative to the printing system 300, having formed the respective focal region 705 of the beam 504, for displacements thereof to each region of the plurality of regions of the markable region 195 are also envisioned without departing from the scope of the present technology.

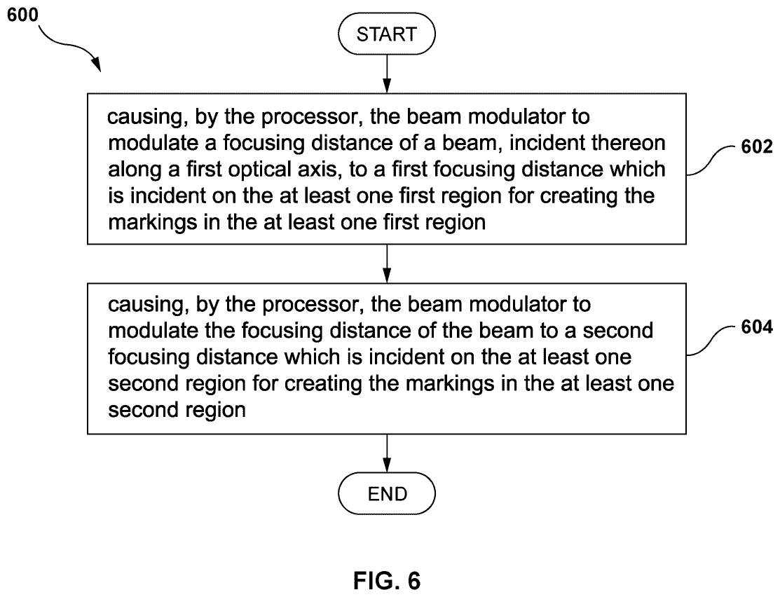

Given the architecture and the examples provided hereinabove, it is possible to execute a method for marking a product, such as the container 190 described above. With reference to FIG. 6, there is depicted a flowchart of a method 600, according to certain non-limiting embodiments of the present technology. The method 600 may be executed by the printing system controller 316 of the printing system 300.

Step 602: Causing, by the Processor, the Beam Modulator to Modulate a Focusing Distance of a Beam, Incident Thereon Along a First Optical Axis, to a First Focusing Distance Which is Incident on the at Least One First Region for Creating the Markings in the at Least One First Region

With further reference to FIG. 7, there is depicted a schematic diagram of applying the beam 504 to different regions defined within the markable region 195 for applying the container markings 199 therein, in accordance with certain non-limiting embodiments of the present technology.

The method 600 commences at step 602 with the printing system controller 316 being configured to (i) identify, based on respective point coordinates, the given region within the markable region 195, such as the first region 201; and (ii) cause the beam modulation component 506 of the printing system 300 to modulate the focusing distance 508 of the beam 504 to a first focusing distance 702 corresponding to the first region 201. By doing so, the printing system controller 316 is configured to form the respective focal region 705 of the beam 504 in the first region 201. Further, the printing system controller 316 can be configured to (i) cause the laser 502 to emit the beam 504 such that its beam energy density value in the respective focal region 705 thereof is greater than the first threshold energy density value associated with the first region 201, which is sufficient to create the container markings 199 therein; and (ii) based on the respective points coordinates, cause displacement of the respective focal region 705 through the first region 201, such as in a given direction 706, thereby applying the container markings 199 therein.

The method 600 hence advances to step 604.

### Step 604: Causing, by the Processor, the Beam Modulator to Modulate the Focusing Distance of the Beam to a Second Focusing Distance Which is Incident on the at Least One Second Region for Creating the Markings in the at Least One Second Region

At step 604, based on the respective point coordinates, the printing system controller 316 can be configured to (i) identify the second region 203 within the markable region 195; and; (ii) cause displacement of the respective focal region 705 of the beam 504, as described above, to a second focusing distance 704 incident to the second region 203.

As mentioned above, the second region 203 can be activated by a same beam energy density value as the first region 201. However, in other non-limiting embodiments of the present technology, the second region 203 can be configured for being activated by a beam energy density value greater than the second threshold energy density value, which is different from the first threshold energy density value associated with the first region 201. To that end, in some non-limiting embodiments of the present technology, the printing system controller 316 can be configured to cause the laser 502 to modulate the beam energy density value of the beam 504 in the respective focal region 705 thereof, as described above. In other non-limiting embodiments of the present technology, the printing system controller 316 can be configured to use the other laser of the printing system 300, as described further above, to generate the other beam whose beam energy density value is greater than the second threshold energy density value threshold sufficient for applying the container markings 199 in the second region 203.

Further, based on the respective point coordinates, the printing system controller 316 can be configured to cause displacement of the respective focal region 705 within the second region 203, such as in the given direction 706, thereby applying the container markings 199 therein.

According to certain non-limiting embodiments of the present technology, each one of the first focusing distance 702 and the second focusing distance 704 can be adjusted, by the beam modulation component 506, such that a depth (not separately numbered) of the respective focal region 705 is no greater than any one of the first region 201 and the second region 203. This may allow creating the container markings 199 only within a desired region of the plurality of region defined within the markable region 195, without touching or damaging other regions thereof. Thus, certain non-limiting embodiments of the printing system 300 can allow creating the container markings 199 on the container 190 more accurately, which may further allow for an increased effectiveness of the process 100 as a whole.

Further, as mentioned above, in some non-limiting embodiments of the present technology, both the first region 201 and the second region 203, under a respective beam energy density value produced by the beam 504 in the respective focal region 705 thereof, can develop a same color. In these embodiments, the container markings 199 thus produced can have 3D effects, such as bevel, shading, and the like. For example, in those embodiments of the printing system 300 where the laser 502 is of the first laser type, such as the NIR laser, the container markings 199 formed thereby in the given region, such as the first region 201, can be a carbonization trace therein appearing to be of dark gray color, as an example. In other embodiments where laser 502 is of the second laser type, such as the carbon dioxide laser, the container markings 199 formed thereby in the given region, such as the second region 203, result from foaming the second region 203 in the given direction 706. In these embodiments, the container markings 199 in the second region can appear to be of light gray or white color, as an example.

However, in other non-limiting embodiments of the present technology, each one of the first region 201 and the second region 203 of the markable region 195 can develop different colors under the respective beam energy density value produced by the beam 504 in the respective focal region 705 thereof. As a result, in these embodiments, the container markings 199 can include different colors, as mentioned above.

Similarly, an additional, third, region (not depicted) of the markable region 195 can be defined, for example, through a depth of the inner skin layer 154, and the printing system controller 316 can be configured to apply the container markings 199 therein either of the same color or of a different color as described above.

Additionally, it should be noted that although, in the embodiments illustrated in FIG. 7, each one of the first region 201 and the second region 203 are defined, within the markable region 195, in an individual one of the outer skin layer 158 and the at least one middle layer 156 of the wall of the container 190, respectively, depth values of the first region 201 and the second region 203 can be pre-selected such that both thereof can fit a given one of the outer skin layer 158 and the at least one middle layer 156. In yet other non-limiting embodiments of the present technology, the depth value of at least one of the first region 201 and the second region 203 can be pre-selected such that the at least one of the first region 201 and the second region 203 extends through the depth of more than one layers of the wall of the container 190—such as both the outer skin layer 158 and the at least one middle layer 156.

In yet other non-limiting embodiments of the present technology where the container 190 is a monolayer container, each one of the first region 201, the second region 203, and the third region (not depicted) can be defined similarly, at respective depth values thereof from the surface of the markable region 195. Further, in these embodiments, the printing system controller 316 can be configured to apply the container markings 199 of the same or different colors in each one of the first region 201, the second region 203, and the third region (not depicted) in a similar fashion as described above, by modulating the focusing distance 508 of the beam 504 to a respective focusing distance.

The method 600 thus terminates.

It should be expressly understood that application of the method 600 described above is not limited to containers produced from molded articles, such as the container 190, and may include various other products produced from materials reactive to the laser irradiation having predetermined properties, such as, without limitation, fast-moving consumer goods and packaging material thereof, tyres, water supply pipes, and the like.

Thus, with back reference to FIG. 1, the container printing procedure 14 terminates, and the process 100 advances to the container filling and capping procedure 16.

### Container Filling and Capping Procedure

As mentioned above, the container filling and capping procedure can be executed by the filling and capping system (not depicted) configured to put a cap onto the neck portion 151 of the container 190 and to further enclose a volume defined within the container 190.

As mentioned further above, the container filling and capping procedure 16 can be executed before executing the container printing procedure 14.

The process 100 thus terminates.

Various embodiments having been thus described in detail by way of example, it will be apparent to those skilled in the art that variations and modifications may be made without departing from the invention. The invention includes all such variations and modifications as fall within the scope of the appended claims. As such, the described non-limiting embodiment(s) ought to be considered to be merely illustrative of some of the more prominent features and applications. Other beneficial results can be realized by applying the non-limiting embodiments in a different manner or modifying them in ways known to those familiar with the art. This includes the mixing and matching of features, elements and/or functions between various non-limiting embodiment(s) is expressly contemplated herein so that one of ordinary skill in the art would appreciate from this disclosure that features, elements and/or functions of one embodiment may be incorporated into another embodiment as skill in the art would appreciate from this disclosure that features, elements and/or functions of one embodiment may be incorporated into another embodiment as appropriate, unless described otherwise, above. Although the description is made for particular arrangements and methods, the intent and concept thereof may be suitable and applicable to other arrangements and applications.

1. A system for marking a product the product including a markable region having:
at least one first region of a photoactivatable material, at a first depth in a wall of the product, for forming markings when activated by a first incident beam above a first threshold energy density, and
at least one second region of the photoactivatable material, at a second depth in the wall of the product, for forming markings when activated by a second incident beam above a second threshold energy density;
the system comprising:
at least one laser configured to emit a beam having a beam energy density above one of the first threshold energy density and the second threshold energy density at a focal region of the beam and a beam energy density below the one of the first threshold energy density and the second threshold energy density outside of the focal region of the beam;
a beam modulator component configured to modulate a focusing distance of the beam; and
a processor communicatively coupled to the beam modulator component, the processor being configured to cause the beam modulator component to modulate the focusing distance of the beam to:
a first focusing distance which is incident on the at least one first region for creating the markings in the at least one first region, and
a second focusing distance incident on the at least one second region for creating the markings in the at least one second region.

2. The system of claim 1, wherein the at least one first region has been produced from a first photoactivatable material; and the at least one second region have been produced from a second photoactivatable material, different from the first photoactivatable material.

3. The system of claim 2, wherein:
the first photoactivatable material is configured for forming markings of a first color when activated by the first incident beam; and
the second photoactivatable material is configured for forming markings of a second color when activated by the second incident beam; and
wherein the processor is configured to cause the beam modulator component to modulate the focusing distance of the beam to:
the first focusing distance which is incident on the at least one first region for creating the markings of the first color in the at least one first region, and
the second focusing distance incident on the at least one second region for creating the markings of the second color in the at least one second region.

4. The system of claim 3, wherein:
the second threshold energy density is different from the first threshold energy density; and wherein
the at least one laser is configured to modulate the beam energy density of the beam between at least the first threshold energy density and at least the second threshold energy density.

5. The system of claim 4, wherein the processor is further communicatively coupled to the at least one laser for causing adjustments to an emitted energy density of the at least one laser.

6. The system of claim 5, wherein the at least one laser includes at least one tunable laser configured for emitting:
at least a first wavelength suitable for absorption by the first photoactivatable material, and
at least a second wavelength suitable for absorption by the second photoactivatable material.

7. The system of claim 6, wherein the at least one laser is a Near Infrared (NIR) laser.

8. The system of claim 4, wherein:
the at least one laser includes a first laser and a second laser,
the first laser being configured to emit a first beam of at least a first wavelength suitable for absorption by the first photoactivatable material, the first beam having a beam energy density above the first threshold energy density at a first focal region of the first beam and a beam energy density below the first threshold energy density outside the first focal region, and
the second laser being configured to emit a second beam of at least a second wavelength suitable for absorption by the second photoactivatable material, the second beam having a beam energy density above the second threshold energy density at a second focal region of the second beam and a beam energy density below the second threshold energy density outside the second focal region; and
the processor is configured to cause the beam modulator component to modulate:
(i) the focusing distance of the first beam to the first focusing distance for creating the markings of the first color in the at least one first region; and
(ii) the focusing distance of the second beam to the second focusing distance for creating the markings of the second color in the at least one second region.

9. The system of claim 8, wherein the first laser of a first laser type, and the second laser of a second laser type, different from the first laser type.

10. The system of claim 9, wherein:
the first laser type is configured for causing foaming of the at least one first region, thereby creating the markings of the first color therein; and
the second laser is configured for causing carbonization of the at least one second region, thereby creating the markings of the second color therein.

11. The system of claim 9, wherein the first laser type comprises a Near Infrared (NIR) laser, and the second laser type comprises a carbon dioxide laser.

12. The system of claim 3, wherein the first color is different from the second color.

13. The system of claim 3, wherein:
the markable region of the product has at least one third region, at a third depth in a wall of the product, encapsulated by the at least one first region and the at least one second region, the at least one third region being of a third photoactivatable material which can form markings having a third color when activated by an incident beam above a third threshold energy density; and
the processor is further configured to cause the beam modulator component to modulate the focusing distance of the beam to a third focusing distance which is incident on the at least one third region for creating the markings in the at least one third region.

14. The system of claim 1, wherein the at least one laser is configured to emit the beam having the focal region smaller in depth than that of any one of the at least one first region and the at least one second region of the markable region.

15. The system of claim 1, wherein the product has a layered structure and each one of the at least one first region and the at least one second region corresponds to a respective layer of the layered structure.

16. The system of claim 1, wherein the product is a container having been produced from a moldable article.

17. A method for marking a product in a markable region thereof, the markable region including:
at least one first region of a photoactivatable material for forming markings therein when activated by a first incident beam above a first threshold energy density, and
at least one second region of the photoactivatable material for forming the markings therein when activated by a second incident beam above a second threshold energy density;
the method being executable by a processor communicatively coupled to a beam modulator the method comprising:
causing, by the processor, the beam modulator to modulate a focusing distance of a beam incident thereon along a first optical axis, to a first focusing distance which is incident on the at least one first region for creating the markings in the at least one first region; and
causing, by the processor, the beam modulator to modulate the focusing distance of the beam to a second focusing distance which is incident on the at least one second region for creating the markings in the at least one second region,
the beam having a beam energy density above one of the first threshold energy density and the second threshold energy density at a focal region of the beam and a beam energy density below the one of the first threshold energy density and the second threshold energy density outside of the focal region of the beam.
